(19) United States
(12) Patent Application Publication
(10) Pub. No.: US 2025/0062658 A1
(43) Pub. Date: Feb. 20, 2025

(54) HIGH SPEED BLOWER EXHAUST BRUSHLESS MOTOR

(71) Applicant: Dongguan Dayuan Motor Technology Co., Ltd, Dongguan (CN)

(72) Inventor: MINGYU GUANG, Xiantao (CN)

(21) Appl. No.: 18/400,249

(22) Filed: Dec. 29, 2023

(30) Foreign Application Priority Data
Aug. 18, 2023 (CN) 202311050637.7

(51) Int. Cl. H02K 7/14; H02K 1/18; H02K 3/28; H02K 9/06; H02K 9/22

(52) U.S. Cl. CPC H02K 7/14; H02K 1/18; H02K 3/28; H02K 9/06; H02K 9/227; H02K 2203/03

(57) ABSTRACT

A blower exhaust brushless motor includes: a casing including an outer shell and a fix cylinder, two ends of the outer shell are respectively provided with an air inlet and a ventilation outlet; a stator component including a stator rear bracket coaxial arranged with the fix cylinder, a stator coil provided in the stator rear bracket, and a stator rear bearing seat integrated with the stator rear bracket; a rotor component including a rotor shaft, a permanent magnet sleeved in a middle of the rotor shaft, a first bearing and a second bearing that are arranged at two ends of the rotor shaft; an impeller, an end of the rotor shaft passes through the first bearing and is fixedly connected to the impeller to drive the impeller to rotate; a circuit board electrically connected to the stator coil; and a protective sleeve.

### CROSS-REFERENCE TO RELATED APPLICATIONS

This application claims priority to Chinese Patent Application No. 20231150637.7, filed on Aug. 18, 2023, which is hereby incorporated by reference in its entirety.

### TECHNICAL FIELD

The present disclosure relates to the field of various hair dryer exhaust systems with a motor technologies, and in particular, to a high speed blower exhaust brushless motor.

### BACKGROUND

Brushless motor is a type of motor without brushes and commutators (or collector rings), which operates by changing the frequency and waveform of alternating current waves passing through its armature winding coils. Brushless motors are widely used by major manufacturers due to advantages such as high efficiency, low energy consumption, low noise, ultra long lifespan, high reliability, servo control, stepless frequency conversion speed regulation, relatively low cost, and simplicity.

In related technologies, brushless motors mainly include a stator coil component, a rotor component, and an integrally formed motor shell. An interior of the motor shell is provided with a hollow inner cavity, the stator coil component is coaxial with the motor shell and runs through the hollow inner cavity. The rotor component is provided in the stator coil component, two ends of the motor shell are provided with an integrally formed bearing support bracket, two sides of the bearing support bracket at a rear end of the motor shell are provided with a heat dissipation window, and two ends of the rotor component are fixed to the bearing support bracket at two ends of the motor shell through a bearing.

Due to a use of a brushless motor in related technologies, a circuit board is needed to be installed on the bearing support bracket at a rear end of the motor shell to connect the pin so as to achieve an electrical connection between the stator coil component and the circuit board. Due to an obstruction of the circuit board, air discharged from an interior of the motor shell will blow towards the circuit board, thereby forming return air and noise, which affects an air output of the motor. At the same time, due to the bearing support bracket and the motor shell being integrally formed, an assembly process of the stator coil component, the rotor component, and the shell during motor assembly is relatively cumbersome, resulting in low assembly efficiency.

### SUMMARY

A purpose of the present disclosure is to address a phenomenon that wind in a motor shell of a brushless motor in the prior art blows towards s circuit board during use, which forms return air and noise, affects an output air volume of the motor. In addition, a bearing support bracket and the motor shell are integrally formed, resulting in a cumbersome assembly process and low assembly efficiency between a stator coil component and a rotor component with the motor shell during motor assembly. The present disclosure provides a high speed blower exhaust brushless motor.

The technical solution adopted by the present disclosure is: a modular design of a high-speed brushless motor, which includes: a casing, the casing includes an outer shell and a fix cylinder that are coaxially arranged, two ends of the outer shell are respectively provided with an air inlet and a ventilation outlet, a ventilation chamber is formed between the outer shell and the fix cylinder; a stator component provided in the casing, the stator component includes a stator rear bracket coaxially arranged with the fix cylinder, a stator coil provided in the stator rear bracket, and a stator rear bearing seat integrated with the stator rear bracket; one end of the stator rear bracket is located in the fix cylinder, the other end of the stator rear bracket extends out of the fix cylinder, the stator rear bearing seat is located at one end of the stator rear bracket protruding from the fix cylinder, two sides of one end of the stator rear bracket close to the stator rear bearing seat are respectively provide with a heat dissipation port; a rotor component provided in the stator coil, the rotor component includes a rotor shaft, a permanent magnet provided in a middle of the rotor shaft, and a first bearing and a second bearing that are respectively provided at two ends of the rotor shaft, where the rotor shaft is coaxially arranged with the stator rear bracket, one end of the rotor shaft is fixedly connected to one end of the fix cylinder close to the air inlet through the first bearing, the other end of the rotor shaft is fixedly connected to the stator rear bearing seat through the second bearing; an impeller rotatably provided at one end of the fix cylinder facing the air inlet, one end of the rotor shaft passes through the first bearing and is fixedly connected to the impeller to drive the impeller to rotate; a circuit board provided on the stator rear bearing seat and electrically connected to the stator coil for supplying power to the stator coil and causing the stator coil to generate a magnetic field; and a protective sleeve provided on the stator rear bracket for sealing the heat dissipation port.

In an embodiment of the present disclosure, an inner of the outer shell is evenly provided with multiple connection plates, the multiple connection plates are arranged along a length direction of the casing, and the multiple connection plates are evenly distributed along a circumferential direction of the outer shell; two sides of each connection plate are respectively fixedly connected to an inner wall of the casing and an outer side of the fix cylinder so as to achieve a connection and fixation between the fix cylinder and the casing, the ventilation chamber is divided into multiple ventilation grooves under an action of the multiple connection plates.

In an embodiment of the present disclosure, an outer side wall of the stator rear bracket is tightly connected to an inner wall of the fix cylinder so that heat generated by the stator coil can be quickly transferred to the fix cylinder and then dispersed by wind in the ventilation groove.

In an embodiment of the present disclosure, one end of the fix cylinder facing the air inlet is evenly provided with several air intakes, the serval air intakes are evenly provided along a circumferential direction of the fix cylinder, the several air intakes are all connected to an interior of the fix cylinder, the several air intakes are all located at an edge of the fix cylinder allowing wind generated by an rotation of the impeller to blow into the interior of the fix cylinder.

In an embodiment of the present disclosure, one side of the stator coil facing the circuit board is provided with multiple pins, the multiple pins are arranged along a length direction of the stator coil; the circuit board is provided with several through holes, the serval through holes correspond one-to-one with the pins, the pins are welded and fixed to the circuit board after passing through the through holes so as to achieve an electrical connection between the stator coil and the circuit board.

In an embodiment of the present disclosure, the circuit board is provided with multiple heat dissipation slots, the multiple heat dissipation slots all run through the circuit board, the multiple heat dissipation slots are located at an edge of the circuit board, and the multiple heat dissipation slots are evenly distributed along a circumferential direction of the circuit board.

In an embodiment of the present disclosure, the rotor component further includes a limit ring provided on the rotor shaft and a spring provided between the limit ring and the second bearing; the limit ring is fixedly sleeved at one end of the rotor shaft close to the second bearing, the spring is wound outside the rotor shaft, two ends of the spring are respectively fixedly connected to one side between the limit ring and the second bearing that are faced to each other.

In an embodiment of the present disclosure, the fix cylinder and the stator rear bearing seat are respectively provided with a first bearing groove and a second bearing groove, the first bearing groove and the second bearing groove are oppositely arranged, and the first bearing groove and the second bearing groove are configured to install and fix the first bearing and the second bearing, respectively.

After adopting the above technical solution, the beneficial effects of the present disclosure are:
1. When in use, the present application provides power to the stator coil through the circuit board, which generates a magnetic field after the stator coil is energized, which causes the rotor component to rotate at high speed in the stator coil, the impeller is driven to rotate, and air is blown towards the fix cylinder in the casing, that is, air is sucked from an inlet of the casing and air is outputted from an outlet of the casing, thereby achieving an output of air volume, and also dissipating heat in the casing. The heat dissipation port is enclosed by a protective sleeve, so that the air blown out of the air outlet is discharged along an outer wall of the protective sleeve, avoiding a formation of return air due to the wind blown out by the impeller passing through the heat dissipation port on the circuit board, reducing a generation of noise and ensuring the air output. At the same time, the present application modularizes a production of the stator component, the rotor component, and the casing. During assembly, the stator component, the rotor component, and the casing are assembled separately, and then the stator component, the rotor component, and the casing are integrated assembled, which optimizes a production process, improves assembly efficiency, and facilitates the production and promotion of motors.
2. The present application allows the wind generated by the impeller to be blown into the stator rear bracket the through an arrangement of an inlet hole and a heat dissipation groove, thereby blowing the heat generated by the stator coil into the heat dissipation groove for discharge. At the same time, through a tight connection between the stator rear bracket and the fix cylinder, the heat generated by the stator coil can be quickly transferred to an installation cylinder and dissipated by the wind blown into the ventilation chamber by the impeller so as to achieve a stable heat dissipation of the stator coil, with better heat dissipation effect.

### BRIEF DESCRIPTION OF DRAWINGS

In order to provide a clearer explanation of the embodiments of the present disclosure or the technical solutions in the prior art, a brief introduction will be given below to the drawings required in the embodiments or prior art description. It is evident that the drawings in the following description are only some embodiments of the present disclosure. For those skilled in the art, other drawings can be obtained based on these drawings without creative work.

FIG. 1 is a schematic diagram of an overall structure of an embodiment.

FIG. 2 is another perspective view of FIG. 1.

FIG. 3 is an explosion view of an embodiment.

FIG. 4 is a diagram displaying a casing.

FIG. 5 is a diagram displaying a stator component.

FIG. 6 is a diagram displaying a rotor component.

FIG. 7 is a diagram display a circuit board.

Reference number: 1. Casing; 11. Outer shell; 12. Fix cylinder; 121. Air intake; 122. First bearing groove; 13. Air inlet; 14. Ventilation outlet; 15. Connection plate; 16. Ventilation groove; 2. Stator component; 21. Stator rear bracket; 22. Stator coil; 221. Pin; 23. Stator rear bearing seat; 231. Second bearing groove; 24. Heat dissipation port; 3. Rotor component; 31. Rotor shaft; 32. Permanent magnet; 33. First bearing; 34. Second bearing; 35. Limit ring; 36. Spring; 4. Circuit board; 41. Through hole; 42. Heat dissipation slot; 5. Impeller; 6. Protective sleeve.

### DESCRIPTION OF EMBODIMENTS

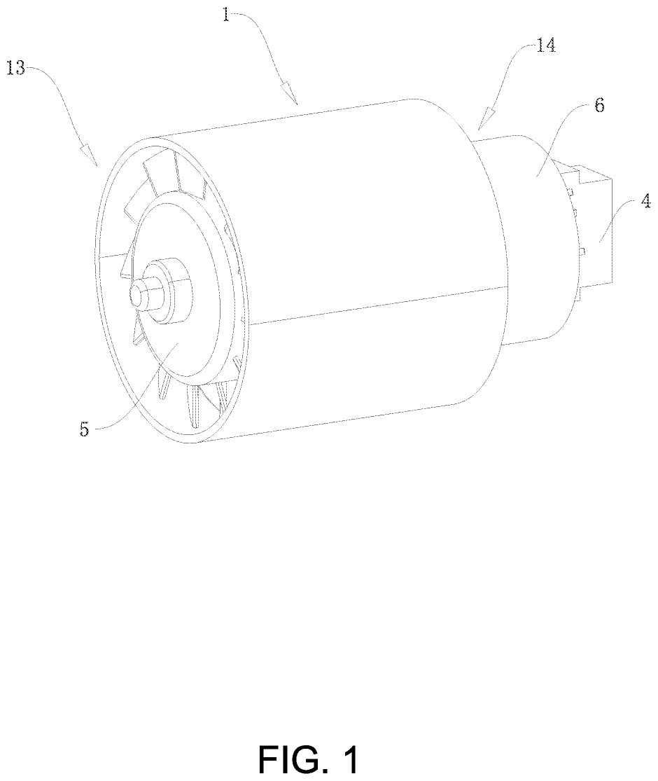

Further detailed explanation of the present disclosure will be provided below in combination with FIGS. 1-7.

This specific embodiment is only an explanation of the present disclosure and is not a limitation of the present disclosure. After reading this specification, those skilled in the art may make modifications to this embodiment as needed without making any creative work, but as long as they fall within the scope of the claims of the present disclosure.

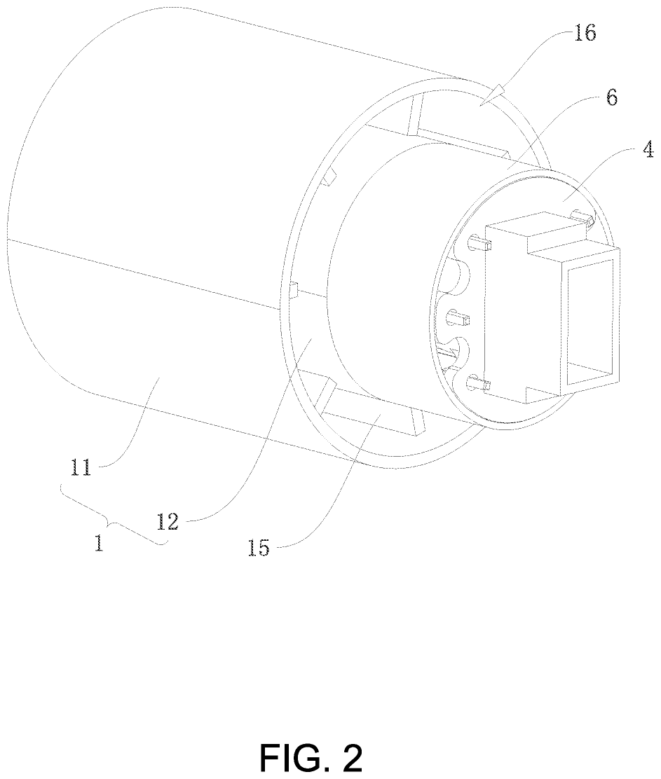

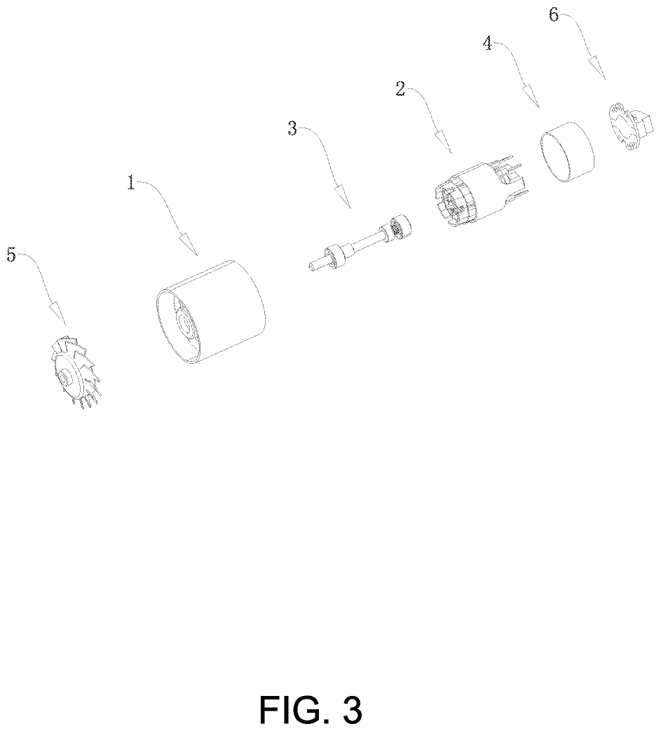

This embodiment relates to a high speed blower exhaust brushless motor, referring to FIGS. 1 and 3, and combined with FIG. 2, which includes a casing 1, a stator component 2, a rotor component 3, a circuit board 4, and an impeller 5. The stator component 2 is provided in the casing 1, the rotor component 3 is provided in the stator component 2, the circuit board 4 is electrically connected to the stator component 2, the impeller 5 is rotatably provided in the casing 1, one end of the rotor component 3 passes through the stator component 2 and is fixedly connected to the impeller 5. The main working process is to supply power to the stator component 2 through the circuit board 4, the stator component 2 is caused to generate a magnetic field, thereby causing the rotor component 3 to rotate at high speed in the stator component 2, while the impeller 5 is driven to rotate, allowing the impeller 5 to blow air into an interior of the casing 1.

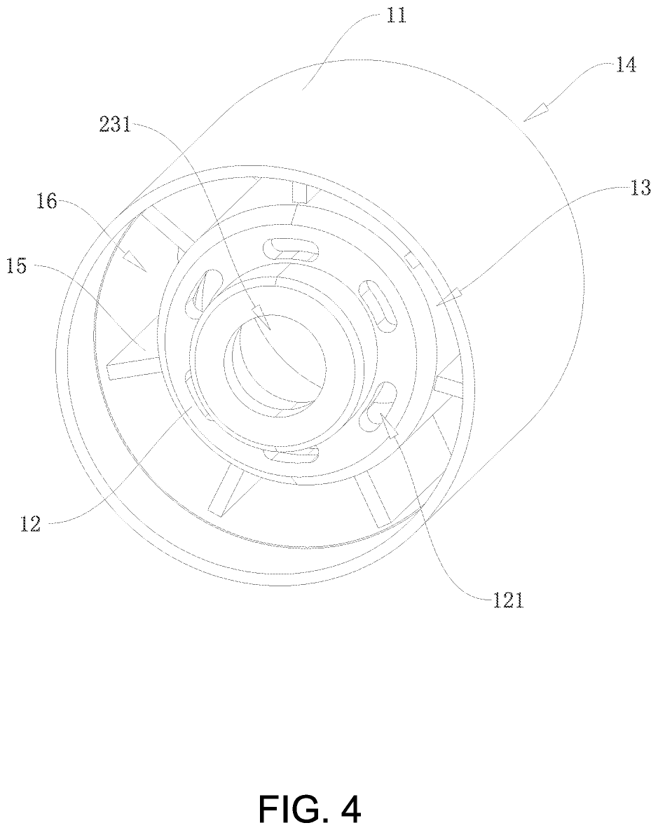

Referring to FIGS. 3 and 4, the casing 1 includes an outer shell 11 and a fix cylinder 12 that are coaxially arranged, where the outer shell 11 is arranged in a cylindrical shape with an opening at two ends, one end of the outer shell 11 is an air inlet 13, and the other end of the outer shell 11 is a ventilation outlet 14. The fix cylinder 12 is arranged in a cylindrical shape with one end closed, and a closed end of the fix cylinder 12 is facing the air inlet 13, an open end of the fix cylinder 12 is facing the ventilation outlet 14, and the closed end of the fix cylinder 12 is located in the outer shell 11. The open end of the fix cylinder 12 is flush with the ventilation outlet 14 of the outer shell 11, and a ventilation chamber is formed between the outer shell 11 and the fix cylinder 12.

An inner wall of outer shell 11 is evenly provided with multiple connection plates 15, the multiple connection plates 15 are all arranged along a length direction of the outer shell 11. The multiple connection plates 15 are evenly distributed along a circumferential direction of the outer shell 11, an upper side and a lower side of the multiple connection plates 15 are fixedly connected to the inner wall of the outer shell 11 and an outer side of the fix cylinder 12 to achieve a connection and fixation between the fix cylinder 12 and outer shell 11. The ventilation chamber is divided into multiple ventilation grooves 16 under an action of the multiple connection plates 15. It should be noted that in an actual production process, the outer shell 11, the fix cylinder 12, and the connection plate 15 can be integrated by injection molding.

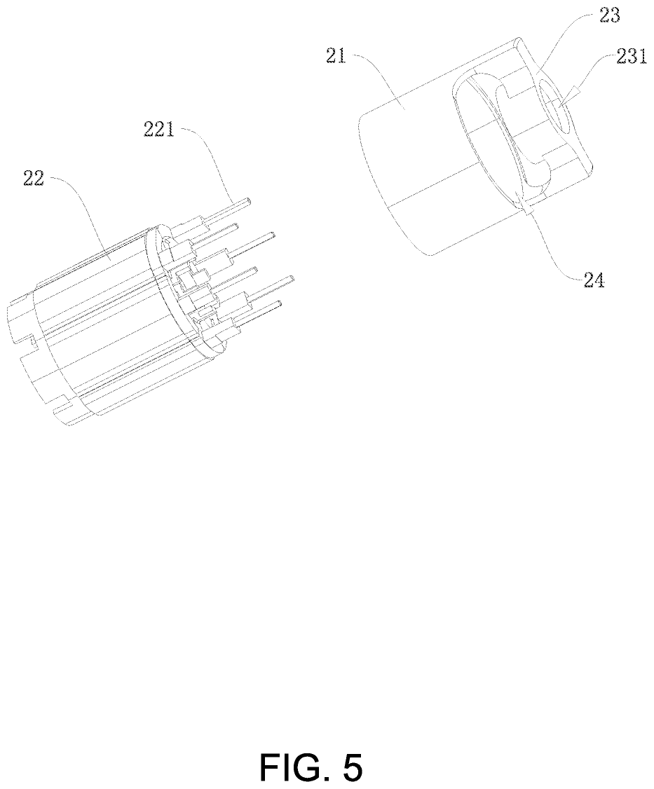

Referring to FIGS. 3 and 5, the stator component 2 is provided in the fix cylinder 12, the stator component 2 includes a stator rear bracket 21 coaxially arranged with the fix cylinder 12, a stator coil 22 arranged in the stator rear bracket 21, and a stator rear bearing seat 23 integrated with the stator rear bracket 21. Where, one end of the stator rear bracket 21 is located in the fix cylinder 12, the other end of the stator rear bracket 21 extends outside the fix cylinder 12, and the stator rear bearing seat 23 is located at one end of the stator rear bracket 21 that extends outside the fix cylinder 12. In order to facilitate internal heat dissipation of the stator rear bracket 21, heat dissipation ports 24 are provided on both sides of one end of the stator rear bracket 21 close to the stator rear bearing seat 23.

In an implementation mode, an outer side wall of the stator rear bracket 21 is tightly connected to an inner wall of the fix cylinder 12, allowing heat generated by the stator coil 22 to be quickly transferred to the fix cylinder 12 and then blown away by wind of the impeller 5 blowing towards the ventilation chamber, thereby improving a heat dissipation effect of the motor.

In an implementation mode, one end of the fix cylinder 12 facing the ventilation outlet 14 (i.e. the closed end of the fix cylinder 12) is provided with several inlet intakes 121, the several inlet intakes 121 are evenly distributed along a circumferential direction of the fix cylinder 12. The several inlet intakes 121 are all connected to an interior of the fix cylinder 12, and the serval inlet intakes 121 are located at an edge of the fix cylinder 12, the wind generated by a rotation of the impeller 5 can be blown into the interior of the fix cylinder 12. By providing with the inlet intakes 121, the wind generated by the rotation of the impeller 5 can be blown into the interior of the fix cylinder 12, so that the heat generated by the stator coil 22 can be blown to the heat dissipation port 24 in the fix cylinder 12, thereby improving the heat dissipation effect of the stator coil 22.

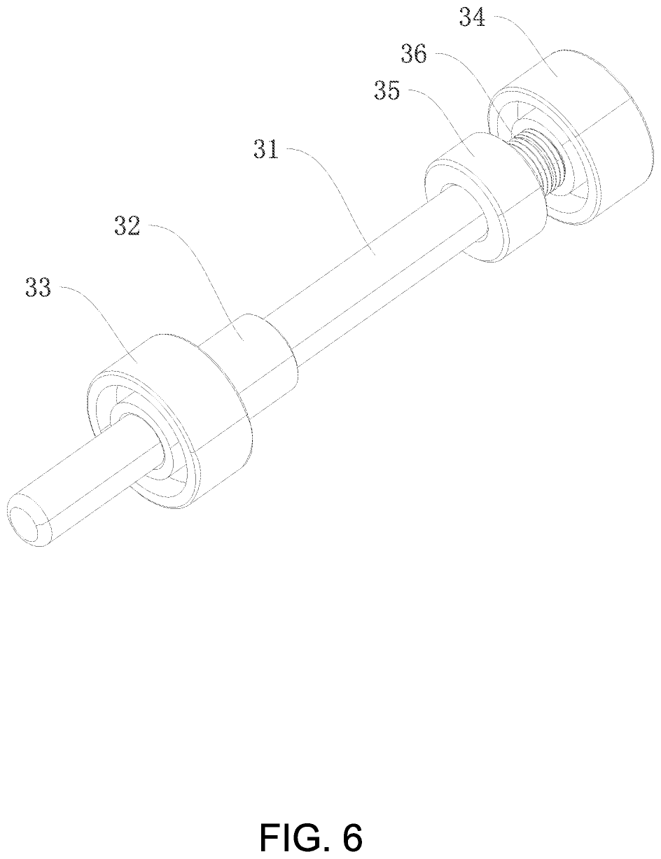

Referring to FIGS. 3 and 6, the rotor component 3 is provided in the stator coil 22, the rotor component 3 includes a rotor shaft 31, a permanent magnet 32 provided in a middle of an outer of the rotor shaft 31, and a first bearing 33 and a second bearing 34 that are provided at both ends of the rotor shaft 31. The rotor shaft 31 is coaxial with the stator installation shaft, one end of the rotor shaft 31 is fixedly connected to the fix cylinder 12 close to the air inlet 13 through the first bearing 33, the other end of the rotor shaft 31 is fixedly connected to the stator rear bearing seat 23 the through the second bearing 34.

The rotor component 3 further includes a limit ring 35 provided on the rotor shaft 31 and a spring 36 provided between the limit ring 35 and the second bearing 34. The limit ring 35 is fixedly sleeved at one end of the rotor shaft 31 close to the second bearing 34, the spring 36 is wound outside the rotor shaft 31. Two ends of the spring 36 are respectively fixedly connected to one end between the limit ring 35 and the second bearing 34 that are faced to each other.

In an implementation mode, referring to FIGS. 4 and 5, in order to achieve a stable assembly of the rotor component 3 and enable the rotor shaft 31 to rotate stably in the stator coil 22, a first bearing groove 122 and a second bearing groove 231 are respectively provided on the fix cylinder 12 and the stator rear bearing seat 23. The first bearing groove 122 and the second bearing groove 231 are oppositely arranged, and the first bearing groove 122 and the second bearing groove 231 are respectively configured to install and fix the first bearing 33 and the second bearing 34.

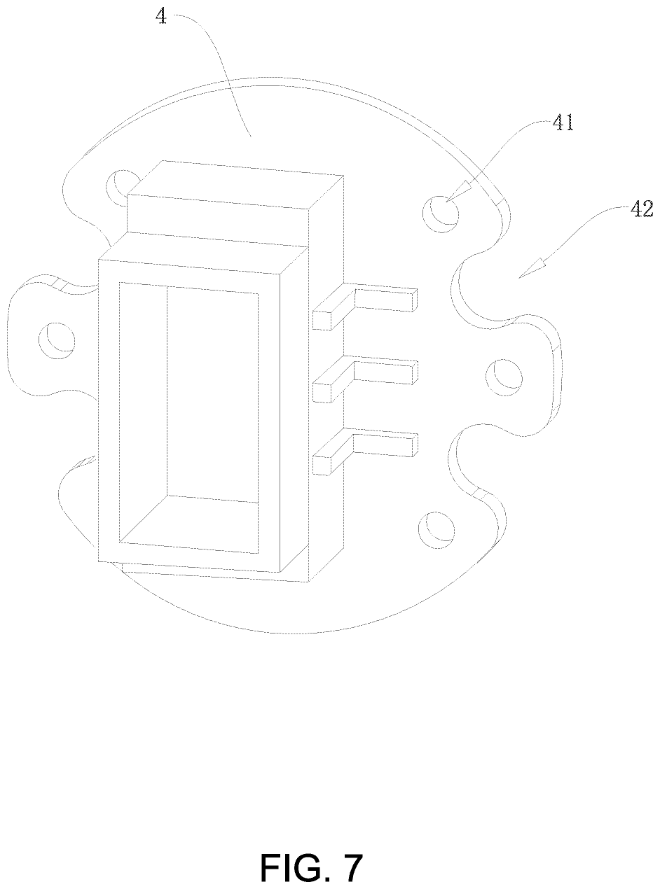

Referring to FIGS. 5 and 7, the circuit board 4 is fixedly installed on one side of the stator rear bearing seat 23 away from the stator rear bracket 12. Multiple pins 221 are provided at one side of the stator coil 22 facing the circuit board 4. The multiple pins 221 are provided along a length direction of the stator coil 22. Several through holes 41 are provided on the circuit board 4, the several through holes 41 correspond one-to-one with pins 221. After passing through the through holes 41, pins 221 are welded and fixed on the circuit board 4, thereby achieving an electrical connection between the stator coil 22 and the circuit board 4.

The impeller 5 is located at the air inlet 13 of the outer shell 11. The impeller 5 is rotatably provided at the closed end of the fix cylinder 12. One end of the rotor shaft 31 passes through the first bearing 33 and extends out of the closed end of the fix cylinder 12, and is fixedly connected to the impeller 5.

Based on FIG. 1, in addition, to prevent the air generated by the rotation of the impeller 5 from blowing from the heat dissipation port 24 to the circuit board 4 to form a return air, a protective sleeve 6 is provided on the stator rear bracket 21 to close the heat dissipation port 24. The protective sleeve 6 is sleeved on the stator rear bracket 21, an outer surface of the protective sleeve 6 is flush with the fix cylinder 12 and abuts against the fix cylinder 12. An inner wall of one end of the protective sleeve 6 far away the fix cylinder 12 is abutted against an outer edge of the circuit board 4.

Referring to FIGS. 3 and 7, further, multiple heat dissipation slots 42 are provided on the circuit board 4, the multiple heat dissipation slots 42 all run through the circuit board 4. The multiple heat dissipation slots 42 are located at an edge of the circuit board 4, and are evenly distributed along a circumferential direction of the circuit board 4. By providing with the heat dissipation slot 42, the wind blown into the fix cylinder 12 by the impeller 5 blows the heat generated by the stator coil 22 to the heat dissipation slot 42 for discharge, thereby avoiding a situation where the heat generated by the stator coil 22 accumulates in the fix cylinder 12 due to a sealing of the heat dissipation port 24 by the protective sleeve 6, and improving the heat dissipation effect.

The working principle of the present disclosure is roughly as follows: during assembly, the stator component 2 and the rotor component 3 are first assembled separately to form modular production, and then the stator component 2 and the rotor component 3 are sequentially installed into the casing 1 to achieve modular assembly of the motor and improve the assembly efficiency of the motor. When in use, power is supplied to the stator coil 22 through the circuit board 4, the stator coil 22 is caused to generate a magnetic field, and the rotor shaft 31 is driven to rotate stably and at high speed in the stator coil 22, while the impeller 5 is also driven to rotate, that is, the impeller 5 stably exports air to the outside. A portion of air generated by the impeller 5 is blown into the fix cylinder 12 through the air inlet hole. The air entering the fix cylinder 12 blows the heat generated by the stator coil 22 to the heat dissipation slot 42 for discharge, achieving heat dissipation of the stator coil 22. Another portion of air generated by the impeller 5 is blown into a ventilation chamber. At this time, the heat generated by the stator coil 22 is transferred to the outer wall of the fix cylinder 12 and is blown by the air in the ventilation chamber to the ventilation outlet 14 for discharge, further heat dissipation of the stator coil 22 is achieved, ensuring the heat dissipation effect of the motor. At the same time, the heat dissipation port 24 is closed by the protective sleeve so that the air generated by the impeller 5 cannot be blown from the heat dissipation port 24 to the circuit board 4 to generate return air, achieving an effect of noise reduction and ensuring the output air volume of the motor.

The above is only used to illustrate the technical solution of the present disclosure and not to limit it. Any other modifications or equivalent substitutions made by ordinary technicians in the art to the technical solution of the present disclosure, as long as they do not deviate from the spirit and scope of the technical solution of the present disclosure, should be included in the scope of the claims of the present disclosure.

What is claimed is:

1. A blower exhaust brushless motor, comprising:
a casing (1), the casing (1) comprises an outer shell (11) and a fix cylinder (12) that are coaxially arranged, wherein two ends of the outer shell (11) are respectively provided with an air inlet (13) and a ventilation outlet (14), a ventilation chamber is formed between the outer shell (11) and the fix cylinder (12);
a stator component (2) provided in the casing (1), wherein the stator component (2) comprises a stator rear bracket (21) coaxially arranged with the fix cylinder (12), a stator coil (22) provided in the stator rear bracket (21), and a stator rear bearing seat (23) integrated with the stator rear bracket (21); one end of the stator rear bracket (21) is located in the fix cylinder (12), the other end of the stator rear bracket (21) extends out of the fix cylinder (12), the stator rear bearing seat (23) is located at one end of the stator rear bracket (21) protruding from the fix cylinder (12), two sides of one end of the stator rear bracket (21) close to the stator rear bearing seat (23) are respectively provide with a heat dissipation port (24);
a rotor component (3) provided in the stator coil (22), wherein the rotor component (3) comprises a rotor shaft (31), a permanent magnet (32) provided in a middle of the rotor shaft (31), and a first bearing (33) and a second bearing (34) that are respectively provided at two ends of the rotor shaft (31), wherein the rotor shaft (31) is coaxially arranged with the stator rear bracket (21), one end of the rotor shaft (31) is fixedly connected to one end of the fix cylinder (12) close to the air inlet (13) through the first bearing (33), the other end of the rotor shaft (31) is fixedly connected to the stator rear bearing seat (23) through the second bearing (34);
an impeller (5) rotatably provided at one end of the fix cylinder (12) facing the air inlet (13), one end of the rotor shaft (31) passes through the first bearing (33) and is fixedly connected to the impeller (5) to drive the impeller (5) to rotate;
a circuit board (4) provided on the stator rear bearing seat (23) and electrically connected to the stator coil (22) for supplying power to the stator coil (22) and causing the stator coil (22) to generate a magnetic field; and
a protective sleeve (6) provided on the stator rear bracket (21) for sealing the heat dissipation port (24).

2. The blower exhaust brushless motor according to claim 1, wherein an inner of the outer shell (11) is evenly provided with multiple connection plates (15), the multiple connection plates (15) are arranged along a length direction of the casing (1), and the multiple connection plates (15) are evenly distributed along a circumferential direction of the outer shell (11); two sides of each connection plate (15) are respectively fixedly connected to an inner wall of the casing (1) and an outer side of the fix cylinder (12) so as to achieve a connection and fixation between the fix cylinder (12) and the casing (1), the ventilation chamber is divided into multiple ventilation grooves (16) under an action of the multiple connection plates (15).

3. The blower exhaust brushless motor according to claim 2, wherein an outer side wall of the stator rear bracket (21) is tightly connected to an inner wall of the fix cylinder (12) so that heat generated by the stator coil (22) can be quickly transferred to the fix cylinder (12) and then blown away by wind in the ventilation groove (16).

4. The blower exhaust brushless motor according to claim 1, wherein one end of the fix cylinder (12) facing the air inlet (13) is evenly provided with several air intakes (121), the several air intakes (121) are evenly distributed along a circumferential direction of the fix cylinder (12), the several air intakes (121) are all connected to an interior of the fix cylinder (12), the several air intakes (121) are all located at an edge of the fix cylinder (12) allowing wind generated by an rotation of the impeller (5) to blow into the interior of the fix cylinder (12).

5. The blower exhaust brushless motor according to claim 1, wherein one side of the stator coil (22) facing the circuit board (4) is provided with multiple pins (221), the multiple pins (221) are arranged along a length direction of the stator coil (22); the circuit board (4) is provided with several through holes (41), the serval through holes (41) correspond one-to-one with the pins (221), the pins (221) are welded and fixed to the circuit board (4) after passing through the through holes (41) so as to achieve an electrical connection between the stator coil (22) and the circuit board (4).

6. The blower exhaust brushless motor according to claim 1, wherein the circuit board (4) is provided with multiple heat dissipation slots (42), the multiple heat dissipation slots (42) all run through the circuit board (4), the multiple heat dissipation slots (42) are located at an edge of the circuit board (4), and the multiple heat dissipation slots (42) are evenly distributed along a circumferential direction of the circuit board (4).

7. The blower exhaust brushless motor according to claim 1, wherein the rotor component (3) further comprises a limit ring (35) provided on the rotor shaft (31) and a spring (36) provided between the limit ring (35) and the second bearing (34); the limit ring (35) is fixedly sleeved at one end of the rotor shaft (31) close to the second bearing (34), the spring (36) is wound outside the rotor shaft (31), two ends of the spring (36) are respectively fixedly connected to one side between the limit ring (35) and the second bearing (34) that are faced to each other.

8. The blower exhaust brushless motor according to claim 1, wherein the fix cylinder (12) and the stator rear bearing seat (23) are respectively provided with a first bearing groove (122) and a second bearing groove (231), the first bearing groove (122) and the second bearing groove (231) are oppositely arranged, and the first bearing groove (122) and the second bearing groove (231) are configured to install and fix the first bearing (33) and the second bearing (34), respectively.
